(19) United States
(12) Patent Application Publication
(10) Pub. No.: US 2026/0155886 A1
(43) Pub. Date: Jun. 4, 2026

(54) TECHNIQUES FOR AIRCRAFT COMMUNICATION

(71) Applicant: Honeywell International Inc., Charlotte, NC (US)

(72) Inventors: Kalimulla Khan, Bangalore (IN); Kirupakar J, Phoenix, AZ (US); Ramkumar Rajendran, Madurai (IN); Sri Harsha Kosuri, Bangalore (IN); Ramkumar Aridass, Madurai (IN)

(21) Appl. No.: 19/082,177

(22) Filed: Mar. 18, 2025

(30) Foreign Application Priority Data
Nov. 29, 2024 (IN) 202411093829

(51) Int. Cl. H04B 7/185; G08G 5/26; H04L 67/12

(52) U.S. Cl. CPC H04B 7/18506; G08G 5/26; H04L 67/12

(57) ABSTRACT

Techniques for aircraft communication are described. In an aspect, aviation data in a first format is parsed to identify a type of aviation data, where the aviation data includes at least one of textual content and non-textual content. The aviation data is transformed from the first format to a second format compatible to be transmitted over an Aircraft Communications Addressing and Reporting System (ACARS) network in correspondence to the identified type of the aviation data, where the transforming of the aviation data based on the identified type includes invoking graphical libraries to transform non-textual content into a format compatible with the ACARS network. Further, the transformed aviation data is transmitted to at least one destination over the ACARS network. In another aspect, receiving and processing ACARS messages by transforming them into a format suitable for rendering at a destination are provided, where the message includes textual and non-textual content.

### BACKGROUND

Typically, the aviation industry relies on communication techniques facilitating exchange of information between airborne and ground-based personnel to ensure safe and efficient flight operations. Generally, such communication is based on voice commands and simple text messages. For example, Controller Pilot Data Link Communications (CPDLC) used between pilots and Air Traffic Controllers (ATC) is primarily designed for communication through a standard set of simple text based messages. Similarly, dispatchers and pilots generally communicate via voice commands or standard text messages using Aircraft Communication Addressing and Reporting System (ACARS) to plan and negotiate any tactical changes that may be required during the flight.

### SUMMARY

Aspects of the present subject matter provide techniques for aircraft communication.

According to an example of the present subject matter, a method for aircraft communication is provided. The method includes parsing a first set of aviation data in a first format to be transmitted to at least one destination amongst a plurality of destinations. The first set of aviation data is parsed to identify a type of aviation data, where the first set of aviation data includes at least one of textual content and non-textual content. Further, the first set of aviation data is transformed from the first format to a second format compatible to be transmitted over an Aircraft Communications Addressing and Reporting System (ACARS) network in correspondence to the identified type of the aviation data, where the transforming of the first set of aviation data based on the identified type includes invoking graphical libraries to transform non-textual content into a format compatible with the ACARS network. The transformed first set of aviation data is then transmitted to the at least one destination over the ACARS network.

According to another example of the present subject matter, a system for aircraft communication is provided. The system includes at least one processor, a memory comprising instructions that, when executed by the at least one processor causes a message interpreter to receive a message over an Aircraft Communications Addressing and Reporting System (ACARS) network and parse the message to identify a type of the message. Further, a message synthesizer is to transform the message into a first set of aviation data based on the identified type of message, wherein the transformed first set of aviation data includes at least one of textual content and non-textual content and provide the first set of aviation data at least for rendering at a destination.

According to another example of the present subject matter, a non-transitory computer readable medium containing program instruction for aircraft communication is provided, that, when executed, causes the processor to parse a first set of aviation data in a first format to be transmitted to at least one destination amongst a plurality of destinations, to identify a type of aviation data, where the first set of aviation data includes at least one of textual content and non-textual content, transform the first set of aviation data from the first format to a second format compatible to be transmitted over an Aircraft Communications Addressing and Reporting System (ACARS) network in correspondence to the identified type of the aviation data, where the transforming of the first set of aviation data based on the identified type includes invoking graphical libraries to transform non-textual content into a format compatible with the ACARS network, and transmit a transformed first set of aviation data to the at least one destination over the ACARS network.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates an environment for aircraft communication, in accordance with an example implementation of the present subject matter.

FIG. 2 illustrates an aircraft communication system, in accordance with an example implementation of the present subject matter.

FIG. 3 illustrates a method for aircraft communication, in accordance with an example implementation of the present subject matter.

FIG. 4 illustrates an example method for aircraft communication, in accordance with an example implementation of the present subject matter.

FIG. 5 illustrates another method for aircraft communication, in accordance with an example implementation of the present subject matter.

FIG. 6 illustrates another example method for aircraft communication, in accordance with an example implementation of the present subject matter.

FIG. 7 illustrates an example method for broadcasting a transformed message to multiple destinations, in accordance with an example implementation of the present subject matter.

FIG. 8 illustrates an example method for aircraft communication between a ground system and a destination, in accordance with an example implementation of the present subject matter.

FIG. 9 illustrates an example method for peer to peer communication between aircrafts, in accordance with an example implementation of the present subject matter.

FIG. 10 illustrates a non-transitory computer-readable medium for aircraft communication, in accordance with an example of the present subject matter.

### DETAILED DESCRIPTION

The present subject matter relates to techniques for aircraft communication.

With increasing complexity of airspace management, communication techniques which merely rely on voice communication and standard ACARS text messages may lack the ability to share complex information such as graphical data, charts, and maps, which may be beneficial for effective joint decision-making. The lack of a comprehensive, context-based messaging system may impede joint decision-making between pilots and dispatchers, especially for tactical flight path changes in real-time. In some implementations, this deficiency may result in delayed responses to changing conditions, potentially affecting flight efficiency and safety. The inability to quickly share and visualize complex data may hinder the collaborative problem-solving process between air and ground crews. Additionally, the lack of support for peer-to-peer communication between nearby aircraft may potentially limit situational awareness and collaborative problem-solving among pilots. This limitation may be particularly noticeable in high-traffic areas or during adverse weather conditions where real-time information sharing between aircraft could enhance safety and efficiency. The absence of direct aircraft-to-aircraft communication in some scenarios may result in missed opportunities for sharing immediate, localized information that could benefit multiple flights in the vicinity.

Accordingly, the present subject matter provides techniques for efficient aircraft communication. To enable seamless communication between, for example, an aircraft and ground, in one example, a first set of aviation data may be parsed at the aircraft to identify a type of aviation data, where the first set of aviation data may include textual content and non-textual content. In one example, non-textual content may include graphical content, audio content, video content, and the like. Further, the type of aviation data may be identified from a predetermined set of message types, such as a weather hazard, flight plan change, runway closure, airport closure, engine data, free text, and the like. On identifying the type of aviation data, the first set of aviation data, which is in a first format, may be transformed from the first format to a second format which is compatible to be transmitted over an Aircraft Communications Addressing and Reporting System (ACARS) network. In one example, transforming of the first set of aviation data from the first format to the second format may be based on the identified type of aviation data. This process may involve invoking graphical libraries to transform non-textual content into a format compatible with the ACARS network. For example, when a pilot needs to send route information on a map to a dispatcher, the system identifies the route details (legs, waypoints, airports) and the map coordinates. The graphical library is invoked to extract these elements from the map image. The extracted information may then be converted into a series of text messages that can be sent via ACARS. Similarly, at the dispatcher's end, incoming messages may be interpreted, synthesized into appropriate formats, and rendered graphically for easy comprehension by ground personnel.

Therefore, techniques of the present subject matter enhance air-to-ground communication while utilizing existing trusted network infrastructure while providing enhanced capabilities for information sharing, collaborative decision-making, and intuitive communication between aircraft and ground personnel. Techniques of the present subject matter not only improve the quality and efficiency of air-to-ground communication but also address the specific requirements set forth by regulatory bodies, while maintaining the highest standards of safety and reliability in aviation operations.

The above and other features, aspects, and advantages of the subject matter will be explained with regard to the following description and accompanying figures. It should be noted that the description and figures merely illustrate the principles of the present subject matter along with examples described herein and should not be construed as a limitation to the present subject matter. It is thus understood that various arrangements may be devised that, although not explicitly described or shown herein, embody the principles of the present disclosure. Moreover, all statements herein reciting principles, aspects, and examples thereof, are intended to encompass equivalents thereof. Further, for the sake of simplicity, and without limitation, the same numbers are used throughout the drawings to reference like features and components.

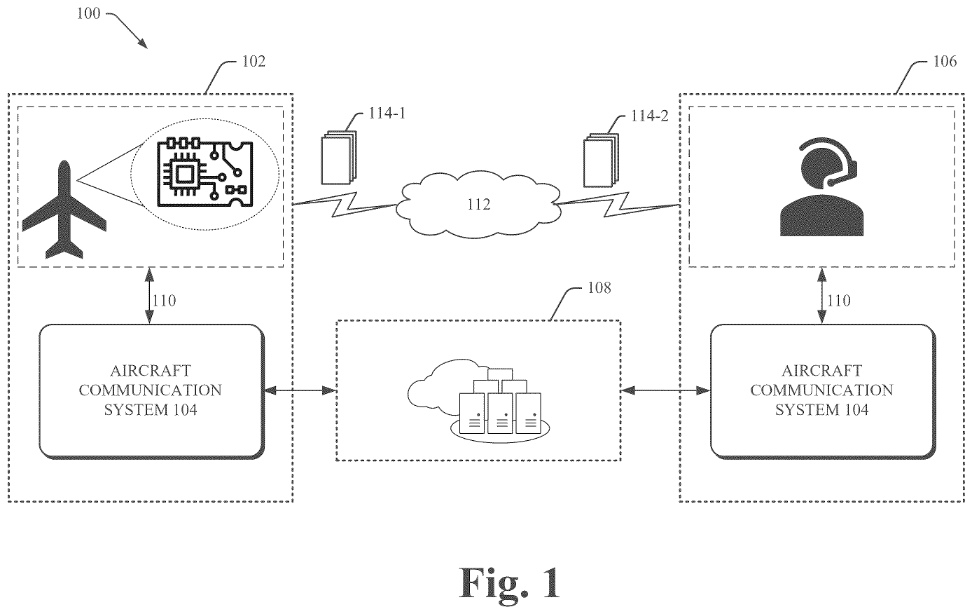

FIG. 1 illustrates an environment 100 for aircraft communication, in accordance with an example implementation of the present subject matter. In one example, the environment 100 may include an avionics system 102, an aircraft communication system 104, a ground based system 106, an aviation cloud service 108, and the like. Avionics system 102, for example onboard an aircraft, may be a Flight Management Systems (FMS), Electronic Fight Bag (EFB), onboard avionic computers, Aircraft Condition Monitoring System (ACMS), and the like. Each of the avionics systems 102 may be communicatively coupled to the aircraft communication system 104 to facilitate exchange of information and data between airborne personnel and ground-based personnel to ensure safe and efficient flight operations, or for optimizing communication between two aircrafts, and the like.

In one example, the aircraft communication system 104 may be part of a source device (not shown in the figure), where the source device may be an Internet of things (IOT) device, any computing system, a personal computer, a laptop, a tablet, a mobile phone, a storage array, a server, a computing device, a distributed computing system, or the like. In another example, the aircraft communication system may be hosted on a server (not shown in the figure) that may communicate with the source device. In one example, avionics systems 102 and the aircraft communication system 104 may communicate over a first network 110. The network 110 may be a wireless network or a combination of a wired and wireless network. The network 110 can also include a collection of individual networks, interconnected with each other and functioning as a single large network, such as the Internet. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN). Depending on the terminology, the communication network includes various network entities, such as gateways and routers; however, such details have been omitted to maintain the brevity of the description. Although not depicted, the aircraft communication system 104 may include other components, such as interfaces to communicate over the network or with external storage or computing devices, display, input/output interfaces, operating systems, applications, data, and other software or hardware components (not depicted for the sake of brevity).

Further, the avionics systems 102 may be communicatively coupled to the ground based systems 106. Ground based systems 106, for example but not limited to, may be Air Traffic Controller (ATC) center systems, Airline Operation Centers (AOC) systems, Airport ground systems, systems in Air Navigation Service Providers (ANSP), systems in Airline Network Operation Centers, and the like. Similar to the avionics systems 102, ground-based systems 106 may be communicatively coupled to the aircraft communication system 104 for optimizing communication between the ground-based systems 106 and the avionics systems 102 on-board an aircraft, to facilitate exchange of information and data between ground-based personnel and airborne personnel to ensure safe and efficient flight operations, or for optimizing communication to multiple aircrafts simultaneously, and the like. In one example, ground-based systems 106 and the aircraft communication system 104 may communicate over the first network 110, as described with reference to communication between avionics systems 102 and the aircraft communication system 104.

In one example, the aircraft communication system 104 may be communicatively coupled to various aviation cloud services 108. In one example, the aviation cloud services 108 may facilitate retrieval of contextual flight operation data for both the avionic systems 102, as well as the ground-based systems 106. This contextual flight operation data may include flight planning and dispatch data, weather data such as Airmen's Meteorological Information (AIRMET) and Significant Meteorological Information (SIGMET), air traffic data, NOTAM data, navigational data, real-time Temporary Flight Restriction (TFR) data, live telemetry data including real-time data from aircraft sensors and systems, prioritized list of detected anomalies, data collected from previous flights, and the like.

In one example, the avionics systems 102 and the ground-based systems 106 may communicate over a second network 112. The second network 112 may include, Satellite Communication networks (STATCOM), Very High Frequency (VHF) networks, High Frequency (HF) networks, Aircraft Communications Addressing and Reporting System (ACARS), Automatic Dependent Surveillance-Broadcast (ADS-B), Controller-Pilot Data Link Communications (CPDLC), Cellular Networks, Wi-Fi networks and the like.

In one example data 114-1 from the avionics systems 102 may be communicated to the ground-based systems 106. Similarly, data 114-2 from the ground-based systems 106 may be communicated to the avionics systems 102. Data 114-1 and data 114-2, collectively referred to as data 114, may be communicated over the second network 112. In one example, data 114 transmitted between avionics and ground systems may include flight plan updates, where pilots may send requests for route changes due to weather conditions or other factors, while ground systems may respond with approved modifications or alternative suggestions. Weather information may be exchanged, with ground systems transmitting real-time weather updates, including turbulence reports, storm cell locations, and wind shear alerts, while aircraft may report encountered weather phenomena to update ground-based forecasts. Aircraft performance data, such as fuel consumption, engine performance, and other system statuses, may be transmitted from the avionics system to ground-based maintenance teams for proactive maintenance planning. Air traffic information may be shared, with ground systems providing updates on airspace congestion, holding patterns, or runway availability, and aircraft reporting their precise position and velocity for improved traffic management. Emergency notifications may be transmitted in both directions, with aircraft sending distress signals or urgent maintenance requests, and ground systems alerting aircraft to emergency situations on the ground affecting flight operations. Operational messages containing information about crew scheduling, catering requirements, or other logistical matters may be exchanged between aircraft and airline operations centers. Navigation database updates may be transmitted from ground systems to ensure aircraft have the most current navigational information. Additionally, ground systems may transmit security alerts or changes in security procedures to aircraft in flight, and the like.

The aircraft communication system 104 may act as an intermediary, processing and routing the data 114 between the avionics systems 102 and the ground-based systems 106 by translating data formats, prioritizing messages, and ensuring secure transmission of information. For instance, the aircraft communication system 104 may interpret incoming messages, synthesize them into appropriate formats, and render them graphically for easy comprehension by pilots or ground personnel, both at the avionics system 102 as well as the ground systems 106. For example, an aircraft's weather radar system may detect a severe thunderstorm cell ahead of the flight path. The avionics system 102 may generate a weather hazard alert containing the storm's location, intensity, and movement. The aircraft communication system 104 may receive this alert and convert the alert data into a format compatible to be transmitted over the ACARS network. This transformed message may be transmitted to the ground-based systems 106 via the second network 112, the second network 112 being, for example, ACARS network. Upon receiving the ACARS message, the aircraft communication system 104 of the ground based system 106 may interpret the ACARS message and convert it back into a format suitable for display on the ground system's 106 interface. The ground system 106 may then render a graphical representation of the weather hazard on its display, potentially overlaying the thunderstorm cell on a map of the relevant airspace, allowing the ground personnel to visualize the weather hazard information in a format consistent with their usual display systems.

Therefore, techniques of the present subject matter enhance air-to-ground communication by providing enhanced capabilities for information sharing, collaborative decision-making, and intuitive communication between aircraft and ground personnel.

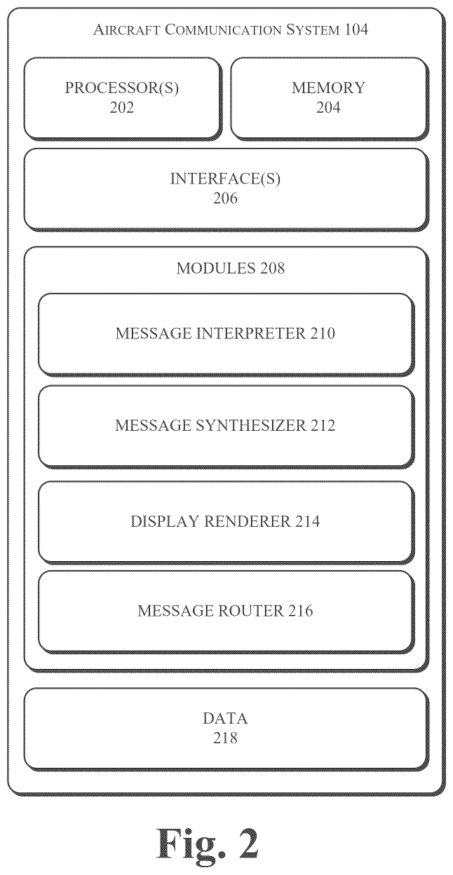

FIG. 2 illustrates the aircraft communication system 104, in accordance with an example implementation of the present subject matter. The aircraft communication system 104, alternatively referred to as system 104, is to enhance aircraft to ground communication. The aircraft communication system 104 may be present in both the aircraft—avionics systems 102 and the ground-based systems 106. While the following description is provided with reference to communication from the aircraft to the ground, and where the aircraft receives information from the ground, similar principles of the present subject matter may be applicable for the ground transmitting messages to an aircraft and receiving messages from the aircraft. In one example, the aircraft communication system 104 may enable bidirectional data exchange between aircraft and ground stations. The system 104 may process and handle messages in a similar manner regardless of the direction of transmission, adapting to the specific needs of both airborne and ground-based operations.

In one example, the system 104 may include a processor 202 and a memory 204 coupled to the processor 202. The functions of functional block labelled as “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage. Other hardware, standard and/or custom, may also be included. Further, an interface(s) 206 may allow the connection or coupling of the system 104 with one or more other devices (say devices or systems within the supply chain network), through a wired (e.g., Local Area Network, i.e., LAN) connection or through a wireless connection (e.g., Bluetooth®, Wi-Fi). The interface(s) 206 may also enable intercommunication between different logical as well as hardware components of the system 104.

The memory 204 may include any computer-readable medium including, for example, volatile memory (e.g., RAM), and/or non-volatile memory (e.g., EPROM, flash memory, etc.).

The system 104 may further include modules 208, such as a message interpreter 210, a message synthesizer 212, and a display renderer 214. The module(s) 208, in one example, may be implemented as a combination of hardware and firmware. In examples described herein, such combinations of hardware and firmware may be implemented in several different ways. For example, the firmware for the module may be processor executable instructions stored on a non-transitory machine-readable storage medium and the hardware for the module may include a processing resource (for example, implemented as either a single processor or a combination of multiple processors), to execute such instructions.

In the present examples, the machine-readable storage medium may store instructions that, when executed by the processing resource, implement the functionalities of the module(s) 208. In such examples, the system 104 may include the machine-readable storage medium storing the instructions and the processing resource to execute the instructions. In other examples of the present subject matter, the machine-readable storage medium may be located at a different location but accessible to the aircraft communication system 104 and the processor 202.

The system 104 may further include data 218, that serves, amongst other things, as a repository for storing data that may be fetched, processed, received, or generated by the modules 208. In one example, the data 218 may be in both, structured and unstructured data formats. The data 218 of various data types, such as flight plan information, aircraft position data, weather information, airspace restrictions, air traffic control messages, navigation data, aircraft performance parameters, crew information, maintenance records, airport and runway data, operational alerts, communication logs, security-related data, passenger manifests, cargo details, fuel consumption data, flight history records, regulatory compliance information, emergency procedure guidelines, and the like. In an example, the data 218 may be stored in the memory 204.

In one example, to transmit a message from an aircraft to the ground system, the message interpreter 210 of the aircraft communication system 104 may parse a first set of aviation data to be transmitted. The first set of aviation data may include textual content and non-textual content. Textual content may include flight plans, weather reports, air traffic control instructions, crew messages, and the like. On the other hand, non-textual content may include graphical content such as charts, maps, or diagrams relevant to the flight, audio content such as voice communications or alerts, and video content such as footage from aircraft cameras or instructional videos, and the like.

In one example, the first set of aviation data may be parsed to identify

a type of aviation data. The type of aviation data may be classified as, for example but not limited to, a weather hazard, flight plan change, airport closure, runway closure, engine out, free text, airspace restrictions, air traffic control instructions, maintenance alerts, navigation database updates, fuel status reports, passenger medical emergencies, security threats, crew scheduling changes, turbulence reports, icing conditions, equipment malfunctions, ground delay programs, diversion notifications, and the like. Parsing the first set of aviation data allows identifying type of data to be transmitted to facilitate handling of different types of data appropriately. For example, the message interpreter 210 may parse the first set of aviation data and identify a message to be transmitted to the flight crew as well as ground personnel. For example, the message interpreter 210 may identify a weather alert that is to be transmitted. The parsed data may include information about a developing thunderstorm along the aircraft's planned route. This weather hazard information may include details such as the storm's location, intensity, movement speed and direction, as well as areas of potential turbulence, icing, and the like.

After parsing the first set of aviation data, the message synthesizer 212 may further transform the first set of aviation data from the first format to a second format compatible to be transmitted over an Aircraft Communications Addressing and Reporting System (ACARS) network in correspondence to the identified type of the aviation data. In one example, the message synthesizer 212 may handle various types of data, including both graphical and textual information, adapting its approach based on the content to be transmitted, and accordingly transform the parsed aviation data into an ACARS-compatible format. For example, transforming data may include techniques, for example but not limited to, compressing the data, encoding it according to ACARS protocols, invoking graphical libraries to transform non-textual content into a format compatible with the ACARS network, and the like. For example, when handling visual data on maps, key geographical information or location-specific details may be extracted and converted into text-based formats suitable for ACARS transmission while preserving essential spatial context. For example, when dealing with graphical data, such as a pilot identifying a specific location on a map, the message synthesizer 212 may invoke corresponding graphical libraries to extract and convert visual information into ACARS-compatible text. For instance, if a pilot marks a location of severe turbulence, the system may extract precise coordinates, nearby waypoints, vectors, altitude, and observation time. This data may then be formatted into an ACARS message, for example, using standardized codes. For actionable messages, the synthesizer may structure the data to clearly convey specific instructions or required actions, ensuring that recipients can quickly understand and respond to the information. In cases where graphical representation is beneficial, the system may convert complex data into simplified textual descriptions of charts, graphs, or other visual aids. For more structured data exchange, the synthesizer may format information into flat files, organizing data in a consistent, easily parsable text format. Additionally, the system 104 may be capable of generating auto responders, creating automated messages based on the content of incoming communications, facilitating rapid information exchange without manual intervention. These diverse transformation capabilities enable the message synthesizer to effectively communicate a wide range of aviation data over ACARS, maximizing the utility of existing communication infrastructure. In one example, predefined message formats, abbreviations, or codes specific to communication over the ACARS network may be utilized to transform the first set of aviation data into a transformed first set of aviation data.

Further, in one example, transforming of the first set of aviation data based on the identified type may include identifying one or more graphical elements from the non-textual content, indexing a first set of graphical elements from the one or more graphical elements, and converting the first set of indexed graphical elements into one or more text messages compatible to be transmitted over the ACARS network. For instance, on considering a weather radar image showing a storm, key elements such as the storm's location, intensity, and movement may be identified. Each element may then be assigned a unique identifier. For example, the storm center might be indexed as “SC1”, and its boundaries as “SB1”, “SB2”, and so on. These indexed elements can be converted into text descriptions for transmission via ACARS. At the receiving end, these descriptions can be reconstructed into a visual representation.

In one example, the transformed first set of aviation data may be transmitted to a destination over the ACARS network. In one example, in one example, the transformed first set of aviation data may be split into a plurality of packets for transmission over the ACARS network. For instance, when transmitting a large flight plan change that exceeds ACARS message size limits, the flight plan may be split into multiple packets, where each packet may be assigned a sequence number. These packets may then be transmitted over the ACARS network.

In one example, a destination amongst multiple destinations may be identified, and based on the identified destination, a message router 216 may transmit the transformed first set of aviation data. These multiple destinations may include dispatchers, other airlines, safety personnel, Quality Assurance (QA) departments, other peer pilots, executives, air traffic control entities, meteorological services, maintenance teams, and the like.

The transformed first set of aviation data may be directed towards a single destination, broadcasted to multiple destinations simultaneously, or routed to specific destinations based on the content of each transformed message. In one example, the destination may be identified based on various factors such as the type of aviation data, priority of transmission, specific requirements of different recipients, and the like. For instance, if the transformed data contains critical weather information, the message router 216 might prioritize transmission of such a message to the airline's dispatchers for immediate flight planning adjustments, while also sending it to other airlines operating in the same airspace, and the like. Similarly, safety-related information may be routed to safety personnel, quality control issues to the QA Department, and the like.

Further, the aircraft communication system 104 may receive a message over an Aircraft Communications Addressing and Reporting System (ACARS) network. The received message may contain aviation data that has been transformed and transmitted as described above. Upon receipt of a message, the system 104 may process this message through a series of operations to interpret, synthesize, and display the information in a format easily comprehensible to the end user, such as a pilot, dispatcher, or other aviation personnel. In one example, the message interpreter may receive a message over the Aircraft Communications Addressing and Reporting System (ACARS) network and parse the message to identify a type of the message. For example, when the aircraft communication system 104 is implemented in the avionics systems 102, the message interpreter may parse the message received from dispatcher, or other aviation personnel.

In one example, the message may be parsed to identify the type of message, for example but not limited to, a weather hazard, flight plan change, airport closure, runway closure, engine out, free text, airspace restrictions, air traffic control instructions, maintenance alerts, navigation database updates, fuel status reports, passenger medical emergencies, security threats, crew scheduling changes, turbulence reports, icing conditions, equipment malfunctions, ground delay programs, diversion notifications, and the like. On identifying the type of message, the message synthesizer 212 may, in one example, transform the message into a first set of aviation data based on the identified type of message, where the transformed first set of aviation data includes at least one of textual content and non-textual content. In one example, when the message includes non-textual content, the message may be transformed by using graphical libraries to create visual representations, such as maps, charts, graphs, and the like tailored to the message type.

In one example, the message synthesizer may include models trained using machine learning techniques to efficiently transform messages into ACARS format. For example, but not limited to, these techniques may include natural language processing for interpreting textual data, deep learning for processing complex multi-dimensional information, anomaly detection for identifying unusual events, reinforcement learning for optimizing transmission strategies, dimensionality reduction for data compression, clustering for efficient data grouping, and the like. By leveraging these techniques, the system may dynamically process and analyse various data 218 from multiple sources such as fleet information, flight plans, aircraft configurations, environmental data, live telemetry, and the like, enabling effective communication between aircraft and ground systems while adhering to ACARS standards and aviation communication requirements.

On transforming the message into the first set of aviation data in a format compatible to the system which receives the message, the first set of aviation data may be provided for rendering at a destination. In one example, a display renderer 214 may parse the first set of aviation data to identify the type of aviation data. In one example, the display renderer 214 may analyze the content and structure of the first set of aviation data to identify its type from pre-determined categories, such as weather information, flight plan changes, maintenance alerts, air traffic control instructions, or the like. Techniques such as pattern recognition, keyword recognition, or predefined data schemas specific to different types of aviation messages may be utilized to identify the type of aviation data. On identifying the type of aviation data, in one example, the display render may select a rendering template based on the first set of aviation data. The selected template may then be applied to display the first set of aviation data appropriately. For example, templates may be pre-designed layouts optimized for different types of aviation data, such as map-based templates for geographical information, chart templates for numerical data, timeline templates for temporal information, templates including placeholders for specific data elements, predefined color schemes, and the like.

Further, if the data from the ground, or aircraft, was transmitted by splitting the transformed data into multiple packets, in such a scenario, multiple packets may be buffered to reconstruct the transformed message and may then be rendered on a display of the destination. In one example, the packets may be reassembled and stored as incoming data packets in a buffer and sequence numbers or other identifiers may be used to reconstruct the transformed message.

The following example illustrates transmitting and receiving of a message over an ACARS network in accordance with an example implementation of the present subject matter and is not to be construed as a limitation. For example, a pilot may initiate a flight plan change. In one example, the pilot may mark or indicate a new route on a digital map avoiding an area of turbulence through one or more input interfaces, such as a touchscreen display and the like. This graphical input may be transformed into a series of waypoints and altitudes. These waypoints and altitudes may further be converted into ACARS text messages. In one example, the air communication system may identify that these ACARS text messages are to be transmitted to a ground-based dispatcher. Accordingly, the destination information may be included in the message which may be sent to an ACARS network module. The ACARS network module may utilize this data to transmit the message through the ACARS network. The dispatchers ground system may receive the ACARS message, where the message may be parsed to identify the pilot's message. The pilot's message may be identified as a flight plan change and accordingly, in one example, a map which is needed to render this data effectively may be identified. The appropriate base map may be retrieved and then the new route may be plotted on this map, highlighting the changed portion of the flight plan. The waypoints included in the message may be marked. Additionally, reasons for initiating a change in the flight plan as initiated by the pilot could be presented as a message. The dispatcher may then use this visual representation to evaluate the request, check for any potential conflicts or issues, and respond to the pilot with approval or further instructions.

Therefore, by handling both graphical and textual data, techniques of the present subject matter allow for comprehensive information exchange using existing ACARS infrastructure, enhancing communication capabilities without requiring significant hardware upgrades. This capability to transmit converted graphical content over ACARS significantly enhances the ability exchange complex spatial information, such as weather patterns, flight path changes, or airspace restrictions, using the existing communication infrastructure.

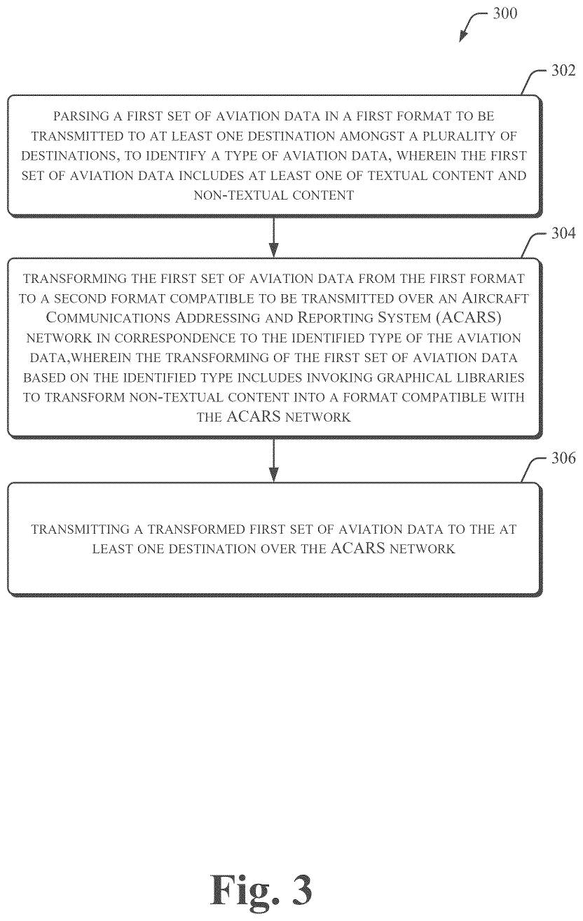

FIGS. 3, 4, 5, and 6 illustrate methods 300, 400, 500, and 600 for aircraft communication, in accordance with examples of the present subject matter. The order in which the methods are described is not intended to be construed as a limitation, and any number of the described method blocks may be combined in any order to implement the methods, or an alternative method. Further, the methods 300, 400, 500, and 600 may be implemented by processing resource or computing device(s) through any suitable hardware, non-transitory machine-readable instructions, or combination thereof.

It may also be understood that methods 300, 400, 500, and 600 may be performed by programmed computing devices, such as the aircraft communication system 104, as depicted in FIG. 2. Furthermore, the methods 300, 400, 500, and 600 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The methods 300, 400, 500, and 600 are described below with reference to the aircraft communication system 104, as described above; other suitable systems for the execution of these methods may also be utilized. Additionally, implementation of the method is not limited to such examples.

FIG. 3 illustrates a method for aircraft communication, in accordance with an example implementation of the present subject matter. In FIG. 3, at block 302 the method includes parsing a first set of aviation data in a first format, to be transmitted to at least one destination amongst a plurality of destinations, such as dispatchers, other airlines, safety personnel, Quality Assurance (QA) departments, other peer pilots, executives, air traffic control entities, meteorological services, maintenance teams, and the like. In one example, the first format may be a format which is compatible with avionics system on-board an aircraft, when the first set of aviation data is being transmitted from the aircraft. In one example, the first set of aviation data may be parsed to identify a type of aviation data, where the first set of aviation data includes at least one of textual content and non-textual content. In one example, non-textual content includes graphical content, audio content, and video content. In one example, the type of aviation data may be identified from a predetermined set of message types, where the predetermined set of message types include at least one of weather hazard, flight plan change, runway closure, airport closure, engine out, free text, and the like.

At block 304, the method 300 includes transforming the first set of aviation data from the first format to a second format compatible to be transmitted over an Aircraft Communications Addressing and Reporting System (ACARS) network in correspondence to the identified type of the aviation data. In one example, when the first set of aviation data includes non-textual content, such as graphical content, the first set of aviation data may include invoking graphical libraries to transform non-textual content into a format compatible with the ACARS network. In one example, transforming of the first set of aviation data based on the identified type includes identifying one or more graphical elements from the non-textual content, indexing a first set of graphical elements from the one or more graphical elements, and converting the first set of indexed graphical elements into one or more text messages compatible to be transmitted over the ACARS network.

At block 306, the method 300 includes transmitting a transformed first set of aviation data to the at least one destination over the ACARS network. In one example, based on the transformed first set of aviation data, a destination for transmitting the transformed message may be identified. In one example, the destination may be identified based on a content of the transformed first set of aviation data. Subsequently, the transformed first set of aviation data may be transmitted to the appropriate destination.

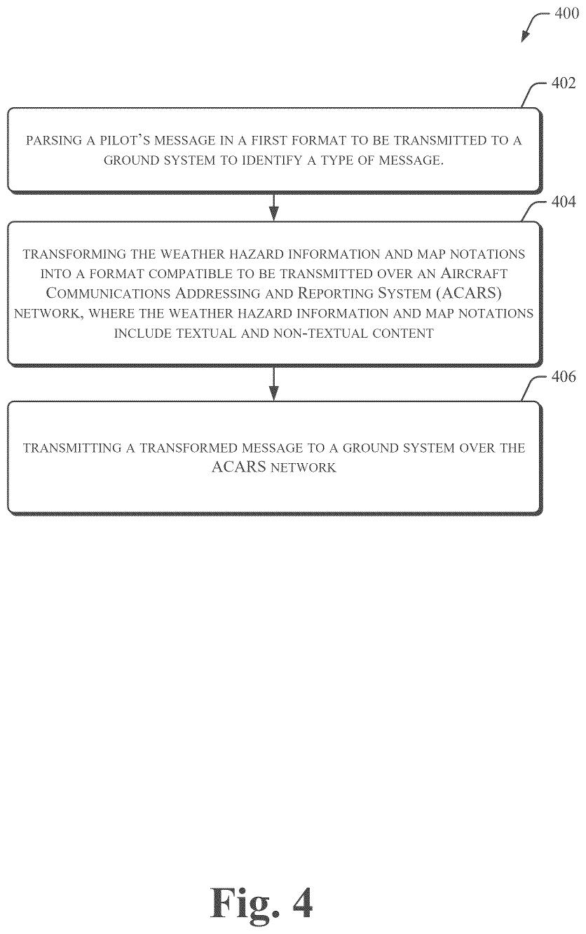

FIG. 4 illustrates an example method 400 for aircraft communication, in accordance with an example implementation of the present subject matter. In FIG. 4, at block 402, the method 400 includes parsing a pilot's message to be transmitted to a ground system. In one example, parsing of the pilot's message may involve analyzing various components of the message to determine its type and content, where the message could include both textual content and non-textual content. For example, the pilot's message may be identified as a weather hazard with specific notations on a map. The pilot's message may be in the first format which is compatible with the avionic interactive system on-board the aircraft, which may enable the pilot to interface with the system. In one example, the pilot's message may be parsed to extract specific details related to the weather hazard, such as the type of hazard, for example, turbulence, icing, thunderstorms, volcanic ash, and the like, its severity level, and geographical coordinates, time of observation and expected duration of the hazard, as well as altitude information, the aircraft's current position, altitude, and flight path in relation to the weather hazard, and the like.

At block 404, the method 400 includes transforming the weather hazard information and map notations into a format compatible to be transmitted over an Aircraft Communications Addressing and Reporting System (ACARS) network, where the weather hazard information and map notations include textual and non-textual content. In one example, appropriate graphical libraries to process and convert map notations or weather-related symbols, into a format that can be transmitted over the ACARS network may be utilized. In one example, the graphical elements or map-based information may be encoded into a text-based or binary format that can be efficiently transmitted through the ACARS network. In one example, different aspects of the message may be split into packets for efficient transmission.

At block 406, the method 400 includes transmitting a transformed message to a ground system over the ACARS network.

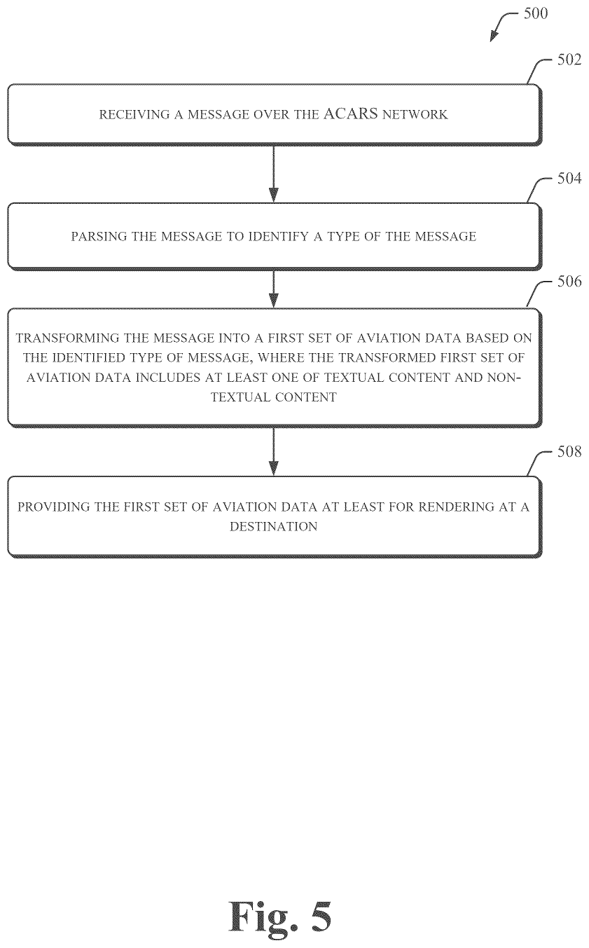

FIG. 5 illustrates another method 500 for aircraft communication, in accordance with an example implementation of the present subject matter. In FIG. 5, at block 502, the method includes 500 includes receiving a message over the ACARS network. In one example, the aircraft may receive this message from a dispatcher, or another flight personnel, any ground-based system, and the like.

At block 504, the method 500 includes parsing the message to identify a type of the message. In one example, the type of message may be identified from a predetermined set of message types, where the predetermined set of message types include at least one of weather hazard, flight plan change, runway closure, airport closure, engine out, free text, and the like.

A block 506, the method 500 includes transforming the message into a first set of aviation data based on the identified type of message, where the transformed first set of aviation data includes at least one of textual content and non-textual content, such as graphical content, audio content, and video content. In one example, based on the type of message identified, the message which is received in ACARS format may be transformed by invoking graphical libraries to transform non-textual content into a format compatible with the system on which the first set of aviation data is to be rendered.

At block 508, the method 500 includes providing the first set of aviation data at least for rendering at a destination. In one example, the first set of aviation data may be rendered on a display of an avionics system onboard the aircraft. In one example, a rendering template may be selected based on the first set of aviation data and the selected template may be applied to display the first set of aviation data. In one example, a plurality of packets received over the ACARS network may be buffered to reconstruct the first set of aviation data.

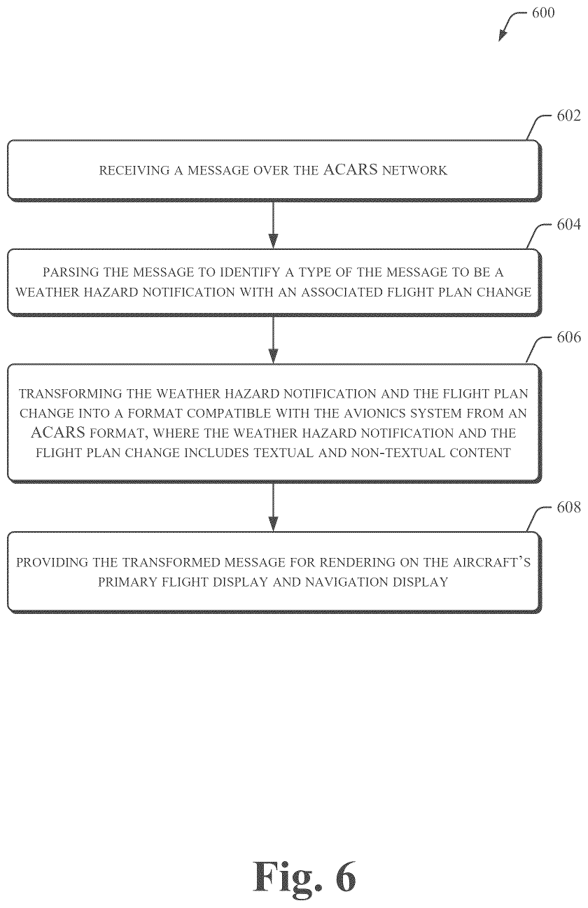

FIG. 6 illustrates another example method 600 for aircraft communication, in accordance with an example implementation of the present subject matter. In FIG. 6, at block 602, the method 600 includes receiving a message over the ACARS network. In one example, the aircraft may receive this message from a dispatcher or ground-based weather monitoring system. The message may contain information about a severe weather hazard along the aircraft's current flight path, along with an alternate route option to avoid the hazard.

At block 604, the method 600 includes parsing the message to identify a type of the message. In this example, the message is identified as a weather hazard notification with an associated flight plan change. The parsing process may extract details such as the type of weather hazard, its location, severity, and expected duration. It may also extract the proposed alternate route information.

A block 606, the method 600 includes transforming the weather hazard notification and the flight plan change into a format compatible with the avionics system from an ACARS format, based on the identified type of message. Both textual content and non-textual content in the message may be transformed into the format compatible with the avionics system from the ACARS format. For instance, the textual content including a description of the weather hazard and the alternate route instructions and non-textual content including a graphical representation of the current flight path, the location of the weather hazard, and the proposed alternate route overlaid on a map may be transformed. In one example, graphical libraries to convert the ACARS format data into visual elements compatible with the aircraft's avionics display system may be invoked.

At block 608, the method 600 includes providing the transformed message for rendering on the aircraft's primary flight display and navigation display. In one example, a rendering template for weather hazard alerts may be selected, which could include a prominent warning symbol and color-coded severity indication. The alternate route may be displayed as a dotted line on the navigation display, allowing the pilot to easily compare it with the current route. In one example, the alternate route and weather information may be overlaid on maps already stored in the databases of the avionics systems. By using existing maps and overlaying new information, data transmission requirements may be reduced while still providing comprehensive situational awareness. Further, if the message was received as multiple packets, these are buffered and reconstructed to ensure the complete weather hazard information and alternate route details are accurately displayed.

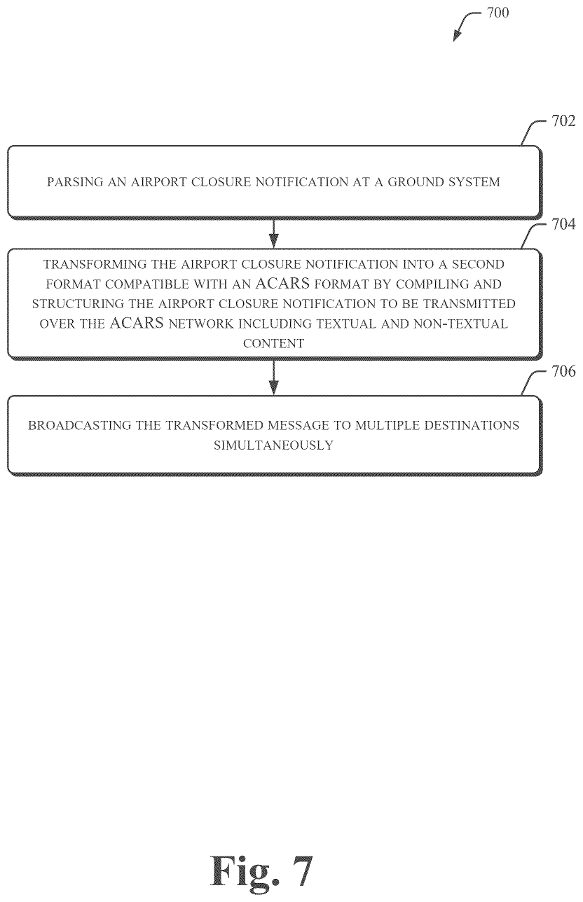

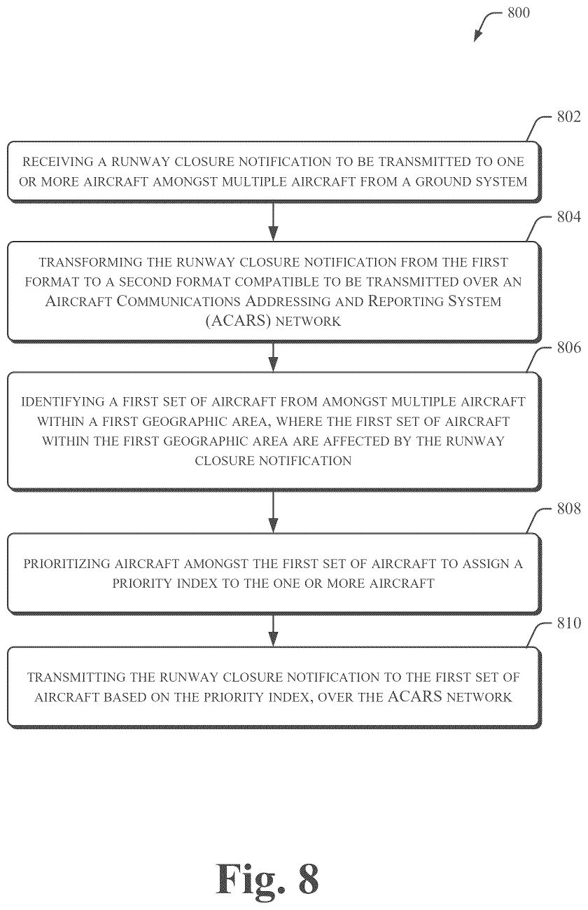

FIGS. 7 and 8 illustrate methods 700 and 800 for aircraft communication, in accordance with examples of the present subject matter. The order in which the methods are described is not intended to be construed as a limitation, and any number of the described method blocks may be combined in any order to implement the methods, or an alternative method. Further, the methods 700 and 800 may be implemented by processing resource or computing device(s) through any suitable hardware, non-transitory machine-readable instructions, or combination thereof.

It may also be understood that methods 700 and 800 may be performed by programmed computing devices, such as the aircraft communication system 104, as depicted in FIG. 2. Furthermore, the methods 700 and 800 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The methods 700 and 800 are described below with reference to the aircraft communication system 104, as described above; other suitable systems for the execution of these methods may also be utilized. Additionally, implementation of the method is not limited to such examples.

FIG. 7 illustrates an example method 700 for broadcasting a transformed message to multiple destinations, in accordance with an example implementation of the present subject matter. In FIG. 7, at block 702, the method 700 includes parsing a message to identify a type of the message, where the message is in a first format compatible with a ground system. The first format may be a format that enables a dispatcher to communicate with the ground system. The message may be identified as an airport closure notification. The parsing process may involve analyzing the structure and content of the message to extract relevant information about the airport closure. This may include identifying key data points such as the affected airport's identifier, the duration of the closure, the reason for closure, and any additional pertinent details. Along with information in a textual format, the airport closure notification may also include a visual representation on a map. The visual representation may include showing nearby alternative airports, displaying affected flight routes, or indicating the radius of impact, and the like.

At block 704, the method 700 includes transforming the airport closure notification into a second format compatible with an ACARS format by compiling and structuring the message to be transmitted over the ACARS network including textual and non-textual content. This transformation process may involve converting the content of the airport closure notification from the first format into a format that conforms to ACARS specifications. The compilation and structuring of the message may include breaking down the information into smaller segments that fit within ACARS message size limitations. The transformation process may also involve encoding the visual map representation into a format that can be transmitted via ACARS. This may include converting graphical elements into text-based descriptions or coordinates that can be reconstructed into a visual format by the receiving system.

At block 706, the method 700 includes broadcasting the transformed message to multiple destinations simultaneously to notify airport closure and enable joint decision making. For example, multiple destinations may include aircraft currently in flight, aircraft on the ground preparing for departure, airline operations centers, air traffic control facilities, airport management and ground operations teams, flight planners, maintenance and logistics teams, connecting airports that may be affected by the closure, and the like. The broadcasting process may utilize the ACARS network to efficiently disseminate the critical information to a wide range of affected stakeholders, for example, ensuring all relevant aircraft receive the airport closure notification in a timely manner, regardless of their current location or flight phase. In one example, the broadcast message may be presented in a format appropriate to the receiving system at the destination. Therefore, broadcasting capabilities allow for efficient dissemination of critical information to multiple aircraft simultaneously enabling rapid, widespread awareness of developing situations, enhancing overall flight safety and efficiency. Broadcasting also facilitates improved situational awareness across the entire airspace. By allowing all aircraft to receive the same real-time updates, it creates a shared understanding of current conditions, potential hazards, and operational changes leading to more coordinated responses to challenges and more efficient use of airspace.

FIG. 8 illustrates an example method 800 for aircraft communication between a ground system and a destination, in accordance with an example implementation of the present subject matter. In FIG. 8, at block 802, the method 800 includes receiving a runway closure notification to be transmitted to one or more aircraft amongst multiple aircrafts from a ground system. In one example, the runway closure notification may be parsed to extract information regarding an airport identifier, the affected runway, the duration of the closure, for example, between 2 pm and 3 pm, and a reason for the closure.

At block 804, transforming the runway closure notification from the first format to a second format compatible to be transmitted over an Aircraft Communications Addressing and Reporting System (ACARS) network. In one example, the runway closure notification may be transformed by structuring textual information into a series of ACARS messages and invoking graphical libraries to transform non-textual content into a format compatible with the ACARS network, for example, by generating a compressed binary format of the non-textual content.

At block 806, the method 800 includes identifying a first set of aircraft from amongst multiple aircrafts within a first geographic area, where the first set of aircraft within the first geographic area are affected by the runway closure notification. In one example, a flight database may be queried to identify aircraft enroute to the said runway between 2 pm and 3 pm, aircraft scheduled to depart from the airport around the said time, and the like.

At block 808, the method includes prioritizing aircraft amongst the first set of aircraft to assign a priority index to the one or more aircraft. In one example, various factors, for example but not limited to, proximity to runway, scheduled landing or takeoff times relative to runway closure period, flexibility in schedule adjustment, and the like may be considered for prioritizing aircraft and accordingly assigning a priority index. For example, aircraft closer to the runway would be assigned a higher priority when compared to aircraft scheduled to land or take off from the affected runway at a timeline which is slightly beyond the closure time. For example, aircraft that are just about to land may be assigned the highest priority, while the ones that are about to land, for example 3:30 pm, which is beyond the closure time may be assigned a lower priority. In another example, the priority may also be assigned based on the possibility for adjustments in the schedule of the aircraft, for example, aircraft with the least scope for modifications in their schedule may be assigned with a higher priority when compared to aircraft with schedules that could be modified.

At block 810, the method 800 includes transmitting the runway closure notification to the first set of aircraft based on the priority index, over the ACARS network. In one example, the order and urgency of transmission may be determined based on the priority index, ensuring that aircraft with higher priority receive the notification with greater precedence.

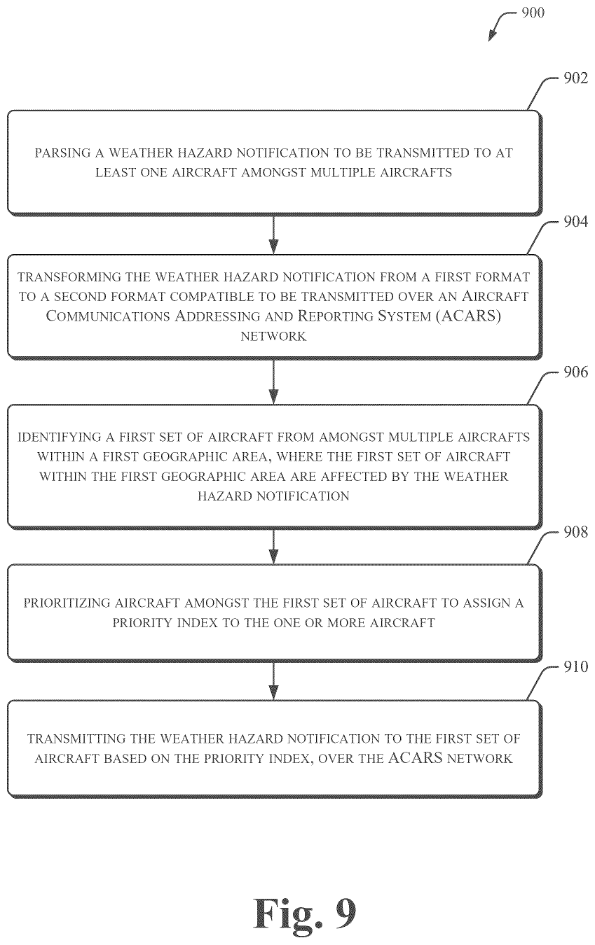

FIG. 9 illustrates an example method 900 for peer to peer communication between aircrafts, in accordance with an example implementation of the present subject matter. The order in which the method is described is not intended to be construed as a limitation, and any number of the described method blocks may be combined in any order to implement the method, or an alternative method. Further, the method 900 may be implemented by processing resource or computing device(s) through any suitable hardware, non-transitory machine-readable instructions, or combination thereof.

It may also be understood that method 900 may be performed by programmed computing devices, such as the aircraft communication system 104, as depicted in FIG. 2. Furthermore, the method 900 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The method 900 is described below with reference to the aircraft communication system 104, as described above; other suitable systems for the execution of these methods may also be utilized. Additionally, implementation of the method is not limited to such examples.

In FIG. 9, at block 902 the method includes 900 includes parsing a weather hazard notification to be transmitted to at least one aircraft amongst multiple aircrafts.

At block 904, the method 900 includes transforming the weather hazard notification from a first format to a second format compatible to be transmitted over an Aircraft Communications Addressing and Reporting System (ACARS) network. In one example, the weather hazard notification may be transformed by structuring textual information into a series of ACARS messages and invoking graphical libraries to transform non-textual content, such as weather radar data, into a format compatible with the ACARS network.

At block 906, the method 900 includes identifying a first set of aircraft from amongst multiple aircrafts within a first geographic area, where the first set of aircraft within the first geographic area are affected by the weather hazard notification. In one example, a flight database may be queried to identify aircraft flying at or above, the current aircraft that identifies the weather hazard-FL380, within a 50 nautical mile radius of the reported severe thunderstorm cell position.

At block 908, the method 900 includes prioritizing aircraft amongst the first set of aircraft to assign a priority index to the one or more aircraft. In one example, various factors, including but not limited to, proximity to the weather hazard, current flight level, aircraft type and capabilities, and planned route may be considered for prioritizing aircraft and accordingly assigning a priority index. For example, aircraft flying closer to the reported weather hazard and at higher altitudes would be assigned a higher priority when compared to aircraft at the edge of the affected area or flying at lower altitudes.

At block 910, the method 900 includes transmitting the weather hazard notification to the first set of aircraft based on the priority index, over the ACARS network. In one example, the order and urgency of transmission may be determined based on the priority index, ensuring that aircraft with higher priority receive the notification with greater precedence. For instance, the weather hazard notification would be transmitted first to aircraft flying at or above FL380 within the affected area. Aircrafts flying in the first geographic area, but which are at an altitude level much lower than the current aircraft, which would be unaffected by the hazard would not receive the alert as they would be determined to be outside the threat zone. Therefore, techniques of the present subject matter facilitate peer-to-peer communication in real-time for faster dissemination of critical information, enabling pilots to make timely decisions about route changes or other necessary actions. By utilizing the existing ACARS infrastructure, aircraft can directly communicate complex data, including both textual and graphical information, to other nearby aircraft without always relying on ground-based intermediaries, thereby enhancing safety by providing immediate, localized information sharing between aircraft, particularly beneficial in high-traffic areas or during adverse weather conditions. It also reduces the load on ground-based systems and potential communication bottlenecks, leading to more efficient airspace management.

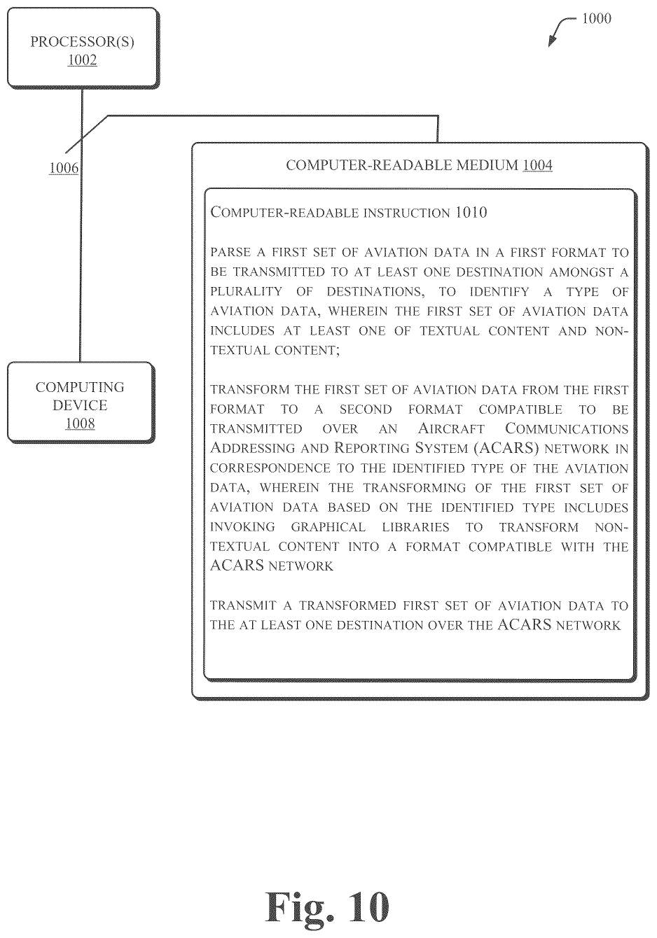

FIG. 10 illustrates a non-transitory computer-readable medium for aircraft communication, in accordance with an example of the present subject matter. In an example, the computing environment 1000 includes processor 1002 communicatively coupled to a non-transitory computer readable medium 1004 through communication link 1006. In an example implementation, the computing environment 1000 may be for example, the system 104 for aircraft communication. In an example, the processor 1002 may have one or more processing resources for fetching and executing computer-readable instructions from the non-transitory computer readable medium 1004. The processor 1002 and the non-transitory computer readable medium 1004 may be implemented, for example, in the system for enhancing communication between aircraft and ground, or between aircrafts.

The non-transitory computer readable medium 1004 may be, for example, an internal memory device or an external memory. In an example implementation, the communication link 1006 may be a network communication link, or other communication links, such as a PCI (Peripheral component interconnect) Express, USB-C (Universal Serial Bus Type-C) interfaces, I2C (Inter-Integrated Circuit) interfaces, and the like. In an example implementation, the non-transitory computer readable medium 1004 includes a set of computer readable instructions 1010 which may be accessed by the processor 1002 through the communication link 1006 and subsequently executed for aircraft communication. The processor(s) 1002 and the non-transitory computer readable medium 1004 may also be communicatively coupled to a computing device 1008 over the network.

Referring to FIG. 10, in an example, the non-transitory computer readable medium 1004 includes computer readable instructions 1010 that cause the processor 1002 to parse a first set of aviation data in a first format to be transmitted to at least one destination amongst a plurality of destinations, to identify a type of aviation data, where the first set of aviation data includes at least one of textual content and non-textual content. The instructions 1010 may further cause the processor 1002 to transform the first set of aviation data from the first format to a second format compatible to be transmitted over an Aircraft Communications Addressing and Reporting System (ACARS) network in correspondence to the identified type of the aviation data, where the transforming of the first set of aviation data based on the identified type includes invoking graphical libraries to transform non-textual content into a format compatible with the ACARS network. Further, the instructions 1010 may cause the processor 1002 to transmit a transformed first set of aviation data to the at least one destination over the ACARS network.

In one example, the instructions 1010 may further cause the processor 1002 to receive a message over the Aircraft Communications Addressing and Reporting System (ACARS) network, parse the message to identify a type of the message, transform the message into a second set of aviation data based on the identified type of message, where the transformed second set of aviation data includes at least one of textual content and non-textual content, and provide the second set of aviation data at least for rendering at a destination.

Although examples of the present subject matter have been described in language specific to methods and/or structural features, it is to be understood that the present subject matter is not limited to the specific methods or features described. Rather, the methods and specific features are disclosed and explained as examples of the present subject matter.

I/We claim:

1. A method for aircraft communication, the method comprising:
parsing a first set of aviation data in a first format to be transmitted to at least one destination amongst a plurality of destinations, to identify a type of aviation data, wherein the first set of aviation data includes at least one of textual content and non-textual content;
transforming the first set of aviation data from the first format to a second format compatible to be transmitted over an Aircraft Communications Addressing and Reporting System (ACARS) network in correspondence to the identified type of the aviation data, wherein the transforming of the first set of aviation data based on the identified type includes invoking graphical libraries to transform non-textual content into a format compatible with the ACARS network; and
transmitting a transformed first set of aviation data to the at least one destination over the ACARS network.

2. The method of claim 1, further comprising splitting the transformed first set of aviation data into a plurality of packets for transmission over the ACARS network.

3. The method of claim 1, comprising:
receiving a message over the ACARS network;
parsing the message to identify a type of the message;
transforming the message into a second set of aviation data based on the identified type of message, wherein the transformed second set of aviation data includes at least one of textual content and non-textual content; and
providing the second set of aviation data at least for rendering at a destination.

4. The method of claim 3, further comprises rendering the transformed second set of aviation data on a display of the destination, wherein the rendering of the transformed second set of aviation data is based on the identified type of aviation data.

5. The method of claim 4, further comprises buffering a plurality of packets received over the ACARS network to render the first set of aviation data on a display of the destination.

6. The method of claim 1, comprises identifying the type of aviation data from a predetermined set of message types, wherein the predetermined set of message types includes at least one of weather hazard, flight plan change, runway closure, airport closure, engine out, and free text.

7. The method of claim 1, wherein the transforming of the first set of aviation data based on the identified type includes:
identifying one or more graphical elements from the non-textual content;
indexing a first set of graphical elements from the one or more graphical elements; and
converting the first set of indexed graphical elements into one or more text messages compatible to be transmitted over the ACARS network.

8. The method of claim 1, wherein the destination is any one of an aircraft and a ground system.

9. The method of claim 1, further comprises:
identifying at least one aircraft from amongst a plurality of aircrafts within a first geographic area, wherein the at least one aircraft within the first geographic area is affected by the first set of aviation data; and
transmitting the first set of aviation data to the at least one within the first geographic area.

10. A system for aircraft communication, the system comprising:
at least one processor;
a memory comprising instructions that, when executed by the at least one processor causes:
a message interpreter to:
receive a message over an Aircraft Communications Addressing and Reporting System (ACARS) network; and
parse the message to identify a type of the message;
a message synthesizer to:
transform the message into a first set of aviation data based on the identified type of message, wherein the transformed first set of aviation data includes at least one of textual content and non-textual content; and
provide the first set of aviation data at least for rendering at a destination.

11. The system of claim 10, further comprising a display renderer to: render the first set of aviation data on a display of a destination.

12. The system of claim 11, wherein the display renderer is to further:
select a rendering template based on the first set of aviation data; and
apply the selected template to display the first set of aviation data.

13. The system of claim 10, wherein the message synthesizer is to buffer a plurality of packets received over the ACARS network to reconstruct the first set of aviation data.

14. The system of claim 10, wherein the non-textual content includes graphical content, audio content, and video content.

15. The system of claim 10, wherein the message interpreter is to further: parse a second set of aviation data in a first format to be transmitted to at least one destination amongst a plurality of destinations, to identify a type of aviation data, wherein the second set of aviation data includes at least one of textual content and non-textual content.

16. The system of claim 15, wherein the message synthesizer is to further transform the second set of aviation data from the first format to a second format compatible to be transmitted over the ACARS network in correspondence to the identified type of the aviation data, wherein the transforming of the second set of aviation data based on the identified type includes invoking graphical libraries to transform non-textual content into a format compatible with the ACARS network.

17. The system of claim 16, wherein the message synthesizer is to further transmit a transformed second set of aviation data to at least one destination amongst a plurality of destinations over the ACARS network.

18. The system of claim 17, wherein the message synthesizer is to further split the transformed second set of aviation data into a plurality of packets for transmission over the ACARS network.

19. A non-transitory computer-readable medium comprising instructions for aircraft communication, the instructions being executable by a processor to:
parse a first set of aviation data in a first format to be transmitted to at least one destination amongst a plurality of destinations, to identify a type of aviation data, wherein the first set of aviation data includes at least one of textual content and non-textual content;
transform the first set of aviation data from the first format to a second format compatible to be transmitted over an Aircraft Communications Addressing and Reporting System (ACARS) network in correspondence to the identified type of the aviation data, wherein the transforming of the first set of aviation data based on the identified type includes invoking graphical libraries to transform non-textual content into a format compatible with the ACARS network; and
transmit a transformed first set of aviation data to the at least one destination over the ACARS network.

20. The non-transitory computer-readable medium as claimed in claim 19, wherein the instructions being executable by a processor are to further:
receive a message over the Aircraft Communications Addressing and Reporting System (ACARS) network;
parse the message to identify a type of the message;
transform the message into a second set of aviation data based on the identified type of message, wherein the transformed second set of aviation data includes at least one of textual content and non-textual content; and
provide the second set of aviation data at least for rendering at a destination.
